(19) United States
(12) Patent Application Publication
(10) Pub. No.: US 2009/0143070 A1
(43) Pub. Date: Jun. 4, 2009

(54) Supporting an Allocation of Radio Resources

(76) Inventors: Kodo Shu, Kawasaki (JP); Kari Leppanen, Helsinki (FI); Sami Savio, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/795,657

(22) PCT Filed: Jan. 20, 2005
(86) PCT No.: PCT/IB05/00137

§ 371 Date: Mar. 28, 2008

(51) Int. Cl. H04W 72/00

(52) U.S. Cl. 455/450

(57) ABSTRACT

The invention relates to a method for supporting in a wireless communication system an allocation of radio resources to connections between mobile stations 10 and access stations 30 of a network. Each access station serves a sub-area. Each connection uses a radio resource. A respective power set is associated to each sub-area. In the network, an indication of radio measurements \vec{PLₖ} performed by a mobile station 10 on signals received from a plurality of sub-areas is received. Further, for a plurality of radio resources, a respective value indicating a signal quality is predicted, which can be expected to occur in a connection between the mobile station 10 and an access station 30 when using a particular radio resource. The prediction is based on power sets associated to the plurality of sub-areas and on the radio measurements performed by the mobile station 10.

### CROSS REFERENCE TO RELATED APPLICATIONS

This application is the U.S. National Stage of International Application Number PCT/IB05/000137 filed on Jan. 20, 2005 which was published in English on Jul. 27, 2006 under International Publication Number WO 2006/077450.

### FIELD OF THE INVENTION

The invention relates to a method for supporting in a wireless communication system an allocation of radio resources to connections between mobile stations and access stations of a wireless communication network. The invention relates equally to a corresponding network element, to a corresponding wireless communication network, to a corresponding wireless communication system, to a corresponding software code and to a corresponding software program product.

### BACKGROUND OF THE INVENTION

In a wireless communication system, a mobile station is enabled to communicate with an access station of a wireless communication network by means of a connection via a radio interface.

The radio resources, which are available for a particular wireless communication system, can be used in different simultaneous connections without interference by splitting the radio resources up into different channels.

For example, in Frequency Division Multiple Access (FDMA), different frequencies are employed for different connections. In Time Division Multiple Access (TDMA), available radio resources are divided into frames, each frame comprising a predetermined number of time-slots. To each connection, a different time-slot may then be assigned in each frame. In Code Division Multiple Access (CDMA), different codes are used in different connections for spreading the data over the bandwidth.

A wireless communication system typically comprises a plurality of fixed stations as access stations, each enabling a communication with mobile stations located in one or more sub-areas served by the fixed station. A sub-area can be for instance a cell of a cellular communication system or a sector of a sectorized wireless communication system. It is to be understood that in case reference is made to a cell in the following, the same applies to a sector.

Using a plurality of cells allows reusing the same channels in various cells. In this case, however, it has to be ensured that interference is kept sufficiently low not only within a respective cell, but also between different cells of the system.

In cellular FDMA/TDMA systems, intra-cell interference is minimized by transmitting signals at different time-slots and/or at different frequency channels in the same cells. Inter-cell interference is managed by defining a co-channel reuse distance. That is, the same time-slots/frequencies are only used by cells having a certain reuse distance to each other, the reuse distance being selected such that the co-channel interference between these cells is reduced sufficiently by the path loss of transmitted signals. However, in order to exploit the available radio resources optimally or avoid excessive usage of bandwidth, a low frequency-reuse, that is, a very small reuse distance, may be preferred in a FDMA/TDMA system. A small reuse distance may lead to severe inter-cell interference, in particular at the cell edges. In this case, a smart Radio Resource Management (RRM) is essential for keeping inter-cell interference at an acceptable level.

In cellular CDMA systems, intra-cell interference is reduced by orthogonal codes, for example at the downlink. Inter-cell interference is relieved by scrambling codes. However, in some situations, for instance in case of high-data-rate users at the cell edges, the inter-cell interference still becomes strong and there is no mechanism available to control the interference in a multi-cell environment.

For cellular systems having low frequency reuse, which implies that the same frequency is reused in cells close to each other, inter-cell interference, or co-channel interference if the same frequency channel is used, is thus a critical issue.

In U.S. Pat. No. 6,259,685, it has been proposed to optimize a network interference level by blocking in relation to time the transmission powers to be used. First, carrier frequencies are allocated to cells with a relatively dense reuse pattern. The cells using the same carrier frequencies are then divided into classes. In each class, the transmission powers of cells belonging to the same class and using the same channel on a time-slot basis is adjusted, so that each cell has an individual time-slot basis transmission power limitation and that, concerning each time-slot, a transmission at the maximum transmission power is allowed only in one cell.

It has further been proposed for non-CDMA type systems that transmissions at high powers in different cells are shifted to different timings. Transmissions at high powers can be used for example for transmission of time-slot, pilot and system information blocks. Due to such a time-shift in a low frequency-reuse environment, inter-cell interference can be managed so that worst interference situations, resulting from simultaneous transmissions at peak power in different cells, can be avoided.

### SUMMARY OF THE INVENTION

It is an object of the invention to support an assignment of radio resources to connections in a wireless communication system.

A method for supporting in a wireless communication system an allocation of radio resources to connections between mobile stations and access stations of a wireless communication network is proposed. Each access station serves at least one sub-area, each connection uses at least one radio resource, and a respective power set is associated to each sub-area served by one of the access stations. The proposed method comprises in the wireless communication network receiving an indication of radio measurements performed by a mobile station on signals received at this mobile station from a plurality of sub-areas. The proposed method moreover comprises in the wireless communication network predicting for a plurality of radio resources a respective value indicating a signal quality, which can be expected to occur in a connection between the mobile station and an access station when using a particular radio resource. The prediction is based on power sets associated to this plurality of sub-areas and on the radio measurements performed by the mobile station.

The access stations can be fixed stations, but equally mobile stations in an ad-hoc network or in a moving network.

The radio resources can be, for example, time-slots of a time domain, different frequencies of a frequency domain, different codes of a code domain, spatial transmission channels of a space domain, like antenna beams or eigenmodes, etc. A radio resource may also correspond to a combination of any of those.

If the radio resources are time-slots, a power set may be for example a power sequence, which associates a respective power value to each time-slot in a time frame.

Moreover, a processing component for a network element of a wireless communication network is proposed, which supports in a wireless communication system an allocation of radio resources to connections between mobile stations and access stations of the wireless communication network. Each access station serves at least one sub-area, each connection in the wireless communication system uses at least one radio resource, and a respective power set is associated to each sub-area served by one of the access stations. The proposed processing component is adapted to receive an indication of radio measurements performed by a mobile station for signals received at the mobile station from a plurality of sub-areas. The proposed processing component is further adapted to predict for a plurality of radio resources a value indicating a signal quality, which can be expected to occur in a connection between the mobile station and an access station when using a particular radio resource, based on power sets associated to the plurality of sub-areas and on the radio measurements performed by the mobile station.

Moreover, a network element for a wireless communication network is proposed, which comprises such a processing component. The network element may correspond for example to the respective access station or to another network element of the network.

Moreover, a wireless communication network is proposed, which comprises such a network element. The wireless communication network may comprise in addition a further network element adapted to associate a respective power set to each sub-area served by one of the access stations. This task could also be performed by one of the network elements comprising the proposed processing component, though. It has further to be noted that the power sets could also, for example, be negotiated directly between different network elements comprising the proposed processing component.

Moreover, a wireless communication system is proposed, which comprises the proposed wireless communication network and in addition a plurality of mobile stations. Each of the mobile stations is adapted to perform radio measurements on signals received at the mobile station from a plurality of sub-areas and to provide an indication of the radio measurements to the wireless communication network.

Moreover, a software code for supporting in a wireless communication system an allocation of radio resources to connections between mobile stations and access stations of a wireless communication network is proposed. It is assumed that each access station serves at least one sub-area, that each connection uses at least one radio resource, and that a respective power set is associated to each sub-area served by one of the access stations. When running in a processing portion of the wireless communication network, the software code realizes the proposed method.

Finally, a software program product storing such a software code is proposed.

The invention proceeds from the consideration that the use of power sets which are assigned to a respective sub-area may be optimized. For example, the radio resource allocation within one sub-area can be optimized. It is proposed that a signal quality related value is determined for each connection based on the assigned power sets and based on radio measurements carried out at the mobile station site on signals received from various sub-areas.

It is an advantage of the invention that the use of power sets allows avoiding critical interference problems in low frequency-reuse scenarios for dynamic packet scheduling.

It is further an advantage of the invention that the radio measurements allow determining interfering sub-areas or mobile stations. Thereby, it allows intelligently predicting the possible interference at each radio resource beforehand.

Based on the interference information, the wireless communication network can then optimally shuffle the order of capacity requests so that the achievable throughput can be maximized. On the other hand, for mobile stations, an optimal times-slot with an adequate signal quality can be selected for transmission.

The predicted value indicating a signal quality can thus be used in particular as a basis for allocating radio resources to a connection between the mobile station and the access station.

The radio measurements carried out by the mobile station can be of various kinds. In one embodiment of the invention, the radio measurements comprise for example determining the path loss of signals received from various sub-areas at the mobile station. In another embodiment of the invention, the radio measurements comprise for example determining a reception power of signals received from various sub-areas at the mobile station.

Also the value indicating a signal quality in a received signal which is predicted can be of various kinds. In one embodiment of the invention, this value is for example a carrier-to-interference ratio (C/I) or a carrier-to-interference-and-noise ratio (C/I+N) of a received signal. In another embodiment of the invention, this value is for example a signal-to-interference-and-noise ratio (SINR) of a received signal. In yet another embodiment of the invention, this value is for example an energy-per-bit-to-noise-density ratio (Eb/No) of a received signal. In particular any variant of these parameters can be employed as well.

The invention enables the wireless communication network to make a radio resource scheduling decision for downlink (DL) and/or for uplink (UL) connections. In both cases, it may be an aim to maximally use the power budget allocated for a sub-area by the power set.

In one embodiment of the invention, the considered connection is thus a downlink connection. In this case, the power sets may comprise for example downlink power sets, each downlink power set associating for a particular sub-area maximum downlink transmission power levels to radio resources.

If no pilot signals are available, the radio measurements can be made using the radio resources used for normal transmissions by each of the access stations. In such a case, the mobile station should have information on the power levels transmitted from a plurality of sub-areas. An access station may, for example, broadcast information on its own downlink power sets as system information in a broadcast channel. Whenever a mobile station performs radio measurements for the sub-areas of a particular access station, it may then obtain the information about the respectively assigned downlink power set from the broadcast channel.

If pilots are available for the radio measurements, a transmission of the power set information by the access stations is not necessary, even though it may be of advantage nevertheless. For example, in order to facilitate a better channel estimation at a mobile station, the assigned power sets can be advantageously signaled by the access stations to the mobile stations.

In a further embodiment of the invention, the considered connection is an uplink connection. In this case, the power sets comprise uplink power sets, each uplink power set associating for a particular sub-area the maximum uplink interference power the access station serving this sub-area is allowed to receive from other sub-areas to radio resources.

In the case of an uplink connection, predicting a respective value indicating a signal quality for a plurality of radio resources may comprise breaking up uplink power sets assigned to other sub-areas into interference contributions allowed at a maximum from the sub-area in which the mobile station is located. Then, a maximum allowed transmission power for each radio resource may be calculated for the mobile station based on the allowed maximum interference contributions and on the radio measurements. The signal quality in the radio resources may then be predicted from the maximum allowed transmission power and the maximum interference power allowed as defined by the uplink power set.

In one embodiment of the invention, a determined transmission power for a particular radio resource, which is selected for an uplink connection, is signaled to the involved mobile station. The mobile station may then set the transmission power for the uplink connection to this transmission power.

In one embodiment of the invention, a radio resource for a particular connection is selected based on a comparison of the predicted value for the signal quality with a target value for the signal quality. Such a target value can be selected for example by means of a mapping table. The mapping table may map for example a desired link performance or a desired link throughput to a respective target value.

The comparison may comprise, for example, determining the ratio between the predicted value and the target value, determining a squared ratio between the predicted value and the target value, determining the difference between the predicted value and the target value, etc.

To a downlink connection, a radio resource may be allocated for which the predicted value indicating a signal quality exceeds a target value indicating a signal quality. Advantageously, the radio resource is allocated more specifically such that the predicted value indicating a signal quality exceeds a target value indicating a signal quality by as small a margin as possible. This allows using a power budget allocated to a particular sub-area by the power sets as fully as possible.

Similarly, to an uplink connection, a radio resource may be allocated for which the predicted value indicating a signal quality exceeds a target value indicating a signal quality.

The power sets which are assigned to the sub-areas may be fixed or variable. To any potentially interfering sub-areas, different power sets should be assigned. Preferably, the power sets which are assigned to potentially interfering sub-areas are moreover “orthogonal” to each other. In the downlink case, this means that that a high transmission power is only assigned to one of these sub-areas for a particular radio resource. In the uplink case, this means that that a low interference power is only assigned to one of these sub-areas for a particular radio resource.

A power set assigned to a sub-area may be changed to achieve an optimal adaptation to the current interference situation. This may be of interest, for example, when a new access station is added nearby or when high traffic-volume mobile stations are located at the edge of a sub-area served by the access station. Any change of a power set has to be signaled to the unit of the communication network in which the method of the invention is implemented.

The assigned power sets may thus be formed for example depending on a load situation in the wireless communication system.

For a high load situation, the assigned power sets may offer to each sub-area at least one radio resource which can be used with a high transmission power for a connection.

For a low load situation in the wireless communication system, assigned downlink power sets may be formed such that for at least one specific radio resource, any of the downlink power sets assigned to a group of potentially interfering sub-areas comprises a low power level. This at least one specific radio resource can then be reserved in the wireless communication network for any sub-area of the group for use with a high downlink transmission power level.

For a low load situation in the wireless communication system, assigned uplink power sets may be formed such that for at least one specific radio resource, any of the uplink power sets assigned to a group of potentially interfering sub-areas comprises a high uplink interference power level. The at least one specific radio resource may then be reserved in the wireless communication network for any sub-area of the group for use with a low uplink interference power level.

In order to make the power margins small, the power sets should be chosen such that the number of available power levels in a set is large, ideally equal to the number of available radio resources. Thereby, the available power set values can cover the needed range with sufficiently small increments. For example, if a downlink frame comprises 24 time-slots, the power set could have 24 different values. These values may be for instance 1 or 2 dB apart. This approach allows finding a time-slot that has just 1 dB of margin, which makes the radio resource usage particularly accurate. In another approach, however, the values could also be for instance 5 dB apart, and the same values could be repeated in the power set.

The invention can be employed for example in cellular systems that utilize TDMA/FDMA and that have a low frequency-reuse, for example around 1/1. The invention can be employed in particular in packet-switched wireless systems, for example in a 3.5 G system, in a 4 G system, in a wireless local area network (WLAN) based system, or in an IEEE 802.16 based system. It is to be understood that other systems could also be enhanced with the present invention. The invention can be used for managing interference and for boosting the capacity, as it allows a very dynamic scheduling of radio resources. The invention lends itself well to distributed, non-centralized RRM, because the amount of required signaling between the access stations is low.

The invention can be employed for example for a conventional radio access network (RAN) architecture, in which the access stations are base stations and the sub-areas are cells. Base stations normally have wire-line connections to a radio network controller (RNC) of the RAN. In such a case, the proposed functions can be distributed to both, the RNC and the base stations. A base station may take care of the interference management between its own cells. Meanwhile, the RNC may take care of the interference management between the base stations, including allocation of the power sets and changes of the power sets.

It is to be understood, however, that the invention can equally be employed with various other radio access architectures, for example in a multi-hop network based system. In a multi-hop network, relay stations (RS) serve a respective cell and exchange information directly via wireless connections with an access point (AP). The relay stations may correspond to the access stations of the invention and the served sectors to the sub-areas. In this case, all proposed functions may be implemented for example in the access point (AP).

### BRIEF DESCRIPTION OF THE FIGURES

Other objects and features of the present invention will become apparent from the following detailed description considered in conjunction with the accompanying drawings.

FIG. 1 is a schematic diagram of a wireless communication system according to an embodiment of the invention;

FIG. 2 is a flow chart illustrating an assignment of DL transmission power in the system of FIG. 1;

FIG. 3 presents diagrams illustrating “orthogonal” power sequences assigned to different cells in the system of FIG. 1;

FIG. 4 presents diagrams illustrating a prediction of C/I ratios for different time-slots in the system of FIG. 1;

FIG. 5 is a mapping table used in the system of FIG. 1 for determining a target C/I; and

FIG. 6 is a flow chart illustrating an assignment of UL transmission power in the system of FIG. 1.

### DETAILED DESCRIPTION OF THE INVENTION

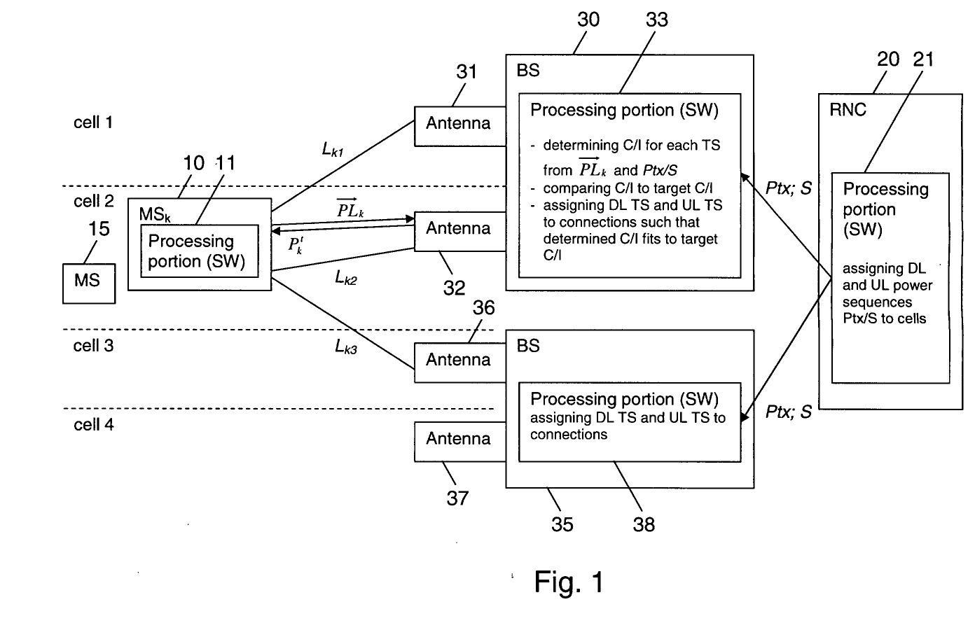

FIG. 1 is a schematic diagram of a wireless communication system, which allows an allocation of time-slots for downlink and uplink connections in accordance with an embodiment of the invention.

The wireless communication system is by way of example a 3 G mobile communication system.

It comprises a mobile communication network and a plurality of mobile stations 10, 15, two of which are depicted.

The mobile communication network includes a radio access network (RAN) with an RNC 20 and a plurality of base stations 30, 35, two of which are depicted. Each base station 30, 35 may serve one or more cells. This is indicated in FIG. 1 by a first group of antennas 31 associated to the first base station 30 for serving a first cell, a second group of antennas 32 associated to the first base station 30 for serving a second cell, a first group of antennas 36 associated to the second base station 35 for serving a third cell, and a second group of antennas 37 associated to the second base station 35 for serving a fourth cell. The base stations 30, 35 are mutually time-synchronized.

In FIG. 1, mobile stations 10, 15 are shown to be located in the second cell served by the second group of antennas 32 of the first base station 30.

The mobile stations 10, 15, the RNC 20 and the base stations 30, 35 all comprise a respective processing portion 11, 21, 33, 38 supporting the allocation of time-slots in accordance with the embodiment of the invention. The processing portions 33, 38 of the base stations form packet schedulers. The support may be implemented in each of the processing portions 11, 21, 33, 38 by software.

For each mobile station 10, 15 one of the base stations 30 is the serving base station, usually the one from which the strongest signals can be received. A mobile station 10 may access the cellular communication network via this serving base station 30.

Each communication between a mobile station 10 and a base station 30 is based on time frames. For a downlink connection enabling a data transmission from the base station 30 to the mobile station 10, a time-slot in a downlink time frame has to be selected and a transmission power has to be determined which is to be used by the base station 30 for transmissions in this downlink time-slot. For an uplink connection enabling a data transmission from a mobile station 10 to a base station 30, a time-slot in an uplink time frame has to be selected and a transmission power has to be determined which is to be used by the mobile station 10 for transmissions in this uplink time-slot.

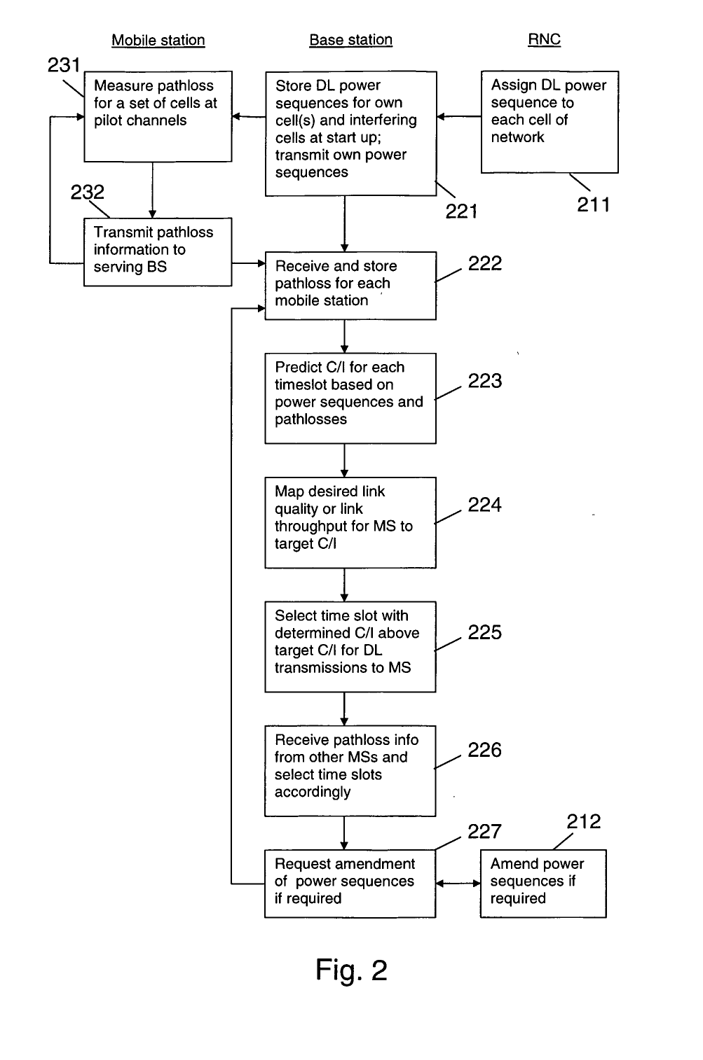

An operation in the system of FIG. 1 for assigning downlink time-slots and transmission powers for transmissions to a respective mobile station 10 is illustrated in the flow chart of FIG. 2.

FIG. 2 presents on the left hand side the operation by the processing portion 11 of a mobile station 10, in the middle the operation by the processing portion 33 of a base station 30 and on the right hand side the operation by the processing portion 21 of the RNC 20.

The RNC 20 assigns a pre-determined downlink power sequence to each cell served by a base station 30, 35 connected to the RNC 20. (step 211)

A downlink power sequence consists of a series of power levels Ptx at a base station should transmit in a respective cell in the defined order. The power sequences indicate a power level only for those time-slots carrying payload data for individual users.

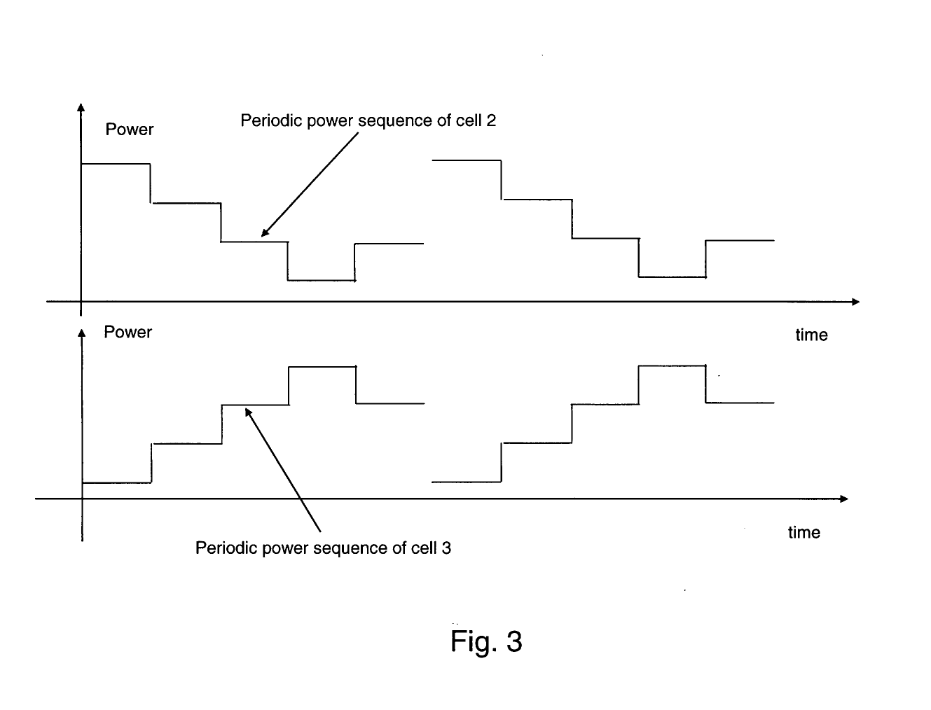

Exemplary power sequences for two cells are indicated in the diagrams of FIG. 3. At the top, a diagram shows a power sequence associated to a first cell over time. The power sequence is repeated periodically. At the bottom, a diagram shows a power sequence associated to a second cell over time. The power sequence is repeated periodically.

Ideally, every cell should employ a power sequence, which is “orthogonal” to neighboring or interfering cells. The “orthogonality” implies roughly that any two interfering cells will not use high transmission powers simultaneously, as in the case of the two power sequences shown in FIG. 3.

The power sequence associated to one cell can be reused in another non-interfering cell. When a new base station is installed, the cells served by it are assigned as well a respective power-sequence that is orthogonal to the neighboring cells. To this end, the group of available power sequences has enough members to allow network extensions without the need to re-assign all power sequences for existing base stations 30, 35 in the network. This feature eases the difficulty in network planning.

At the startup of a base station 30, the RNC 20 provides the base station 30 with the downlink power sequences, which have been assigned to the cells of the base station 30 itself, and the power sequences, which have been assigned to interfering cells. The base station 30 stores the received power sequences for further use. In addition, the base station 30 may broadcast its own downlink power sequences as system information in a broadcast channel for facilitating a channel estimation at the mobile stations 10, 15. (step 221)

Each mobile station 10, 15 of the cellular communication system measures at regular intervals the path loss on pilot channels for all cells, from which it is able to receive the pilot signals (step 231). The path loss information is updated frequently, the updating frequency affecting the accuracy of the presented algorithm. The updating frequency should at least track the variation of slow fading. Path loss is to be understood here to consist of the normal distance- and frequency-dependent path loss and of losses due to shadowing.

In each cell of the cellular communication system, respectively one of the mobile stations 10 transmits the measured path loss information to its serving base station 30 (step 232). The serving base station 30 is the base station making scheduling decisions for the mobile station 10. Typically, it is the base station with the highest received power or the lowest path loss on the pilot channel. The path loss information includes a path loss vector \vec{PLₖ}=[Lₖ₁, Lk₂, . . . Lₖₙ], where Lₖₓ represents the measured path loss between cell x and mobile station k MSₖ. In FIG. 1, by way of example the path losses Lₖ₁, Lₖ₂, Lₖ₃ measured at mobile station 10 for pilot channels from the first, the second and the third cell is indicated, and moreover the resulting path loss vector \vec{PLₖ} which is provided to base station 30 is indicated.

The serving base station 30 receives and stores the received path loss vector from a respective mobile station 10. (step 222) From this path loss vector, the base station 30 knows which cells of the system will be interfering cells for a mobile station 10 it is serving.

Based on the stored path loss vector and the downlink stored power sequences, the base station 30 then predicts for the mobile station 10 the C/(I+N) for each time-slot t of a frame. (step 223) The stored power-sequences indicate the transmission power levels which all cells will use at a certain time-slot t. In interference-limited systems, moreover, the interference I is much larger than the noise N. Therefore, the C/(I+N) at mobile station k for signals transmitted by the i^{th} base station 30 at time-slot t can be expressed as follows:

$${( C / I + N )}_{k}^{t} = {( \frac{C}{I} )}_{k}^{t} = \frac{{Ptx}_{i}^{t} / {L}_{ki}}{{Ptx}_{1}^{t} / {L}_{k 1} + {Ptx}_{2}^{t} / {L}_{k 2} + … + {Ptx}_{n}^{t} / {L}_{kn}}$$

where Ptxᵢ^{t}/Lₖᵢ is not included in the sum

I^{t}=Ptx₁^{t}/Lₖ₁+Ptx₂^{t}/Lₖ₂+ . . . +Ptxₙ^{t}/Lₖₙ.

Ptxᵢ^{t} is the transmission power level employed by the base station 30 for time-slot t in the second cell in accordance with the associated power sequence, and Ptx₁^{t}, Ptx₂^{t}, . . . Ptxₙ^{t} are transmission power levels employed for time-slot t in the interfering cells in accordance with the respectively associated power sequence.

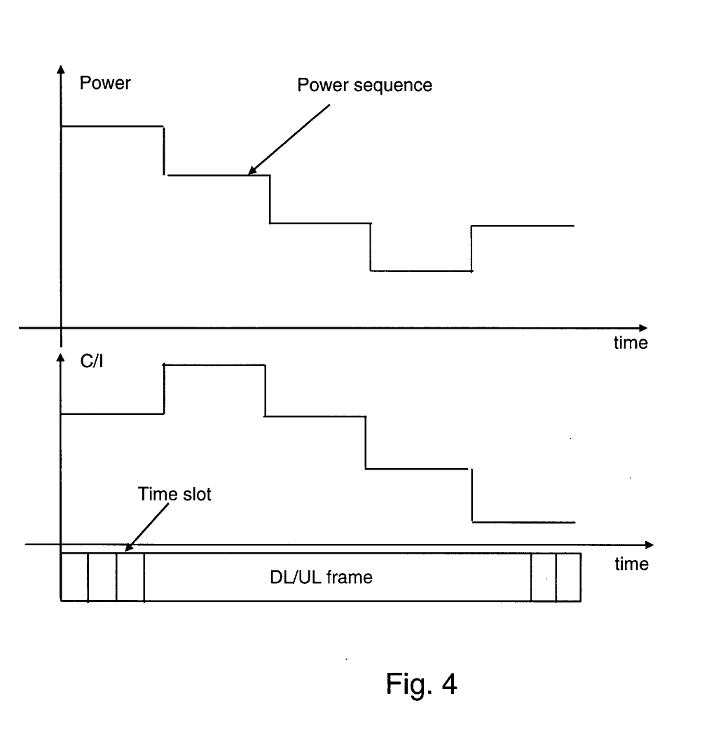

An exemplary predicted C/I is illustrated in FIG. 4. At the bottom, FIG. 4 shows a representation of a frame comprising a plurality of time-slots. At the top, a diagram shows a power sequence associated to the second cell over time, similarly as the diagram at the top of FIG. 3. It can be seen that, in this example, the power sequence associates the same power level to a respective group of four consecutive time-slots. In the middle, a diagram shows the predicted C/I over time for the second cell to which the power sequence at the top is associated. While the variations in the carrier value C depend on the variations of the downlink transmission power employed in the current cell in accordance with the associated power sequence, the interference value I depends on the variation of the downlink transmission power employed in all interfering cells in accordance with the respectively associated power sequence. Therefore, the C/I variation over time differs from the downlink transmission power variation over time.

The predicted

$${( \frac{C}{I} )}_{k}^{t}$$

for each time-slot t is related to the link performance or the link throughput that can be expected at a certain time-slot for mobile station k.

Therefore, the base station 30 maps in addition a required link performance or link throughput to a target C/I for mobile station k, referred to as

$${( \frac{C}{I} )}_{k}^{Target}$$

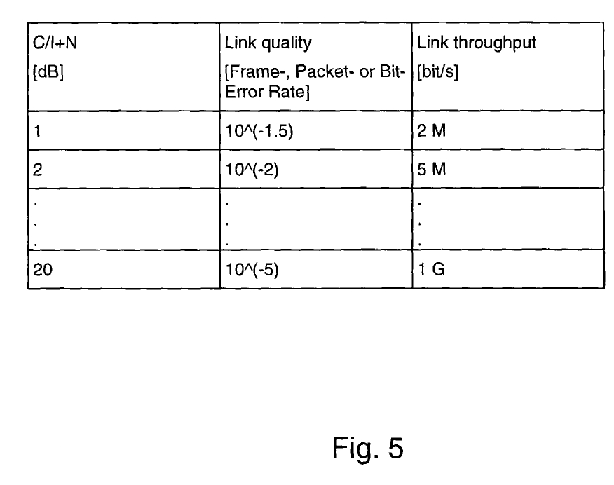

(step 224). The mapping can be performed by means of a mapping table which associates a target C/I or C/I+N value in dB to a required link performance and/or to a required link throughput. The required link performance can be indicated for example by a maximum frame error rate, a maximum packet error rate or a maximum bit error rate, while the required link throughput can be indicated for example in minimum bit/s (bit per second). An exemplary mapping table is represented in FIG. 5. The table can be generated for instance from link-level simulation results or field measurements.

The base station 30 now selects the time-slot t that results in an adequate C/I for the currently considered mobile station k with the smallest margin, that is, the time-slot t, for which

$${η}_{k}^{DL} ( t ) = {( \frac{C}{I} )}_{k}^{Target} / {( \frac{C}{I} )}_{k}^{t} \underline{<} 1$$

is closest to unity. (step 225)

The base station 30 may then transmit packets to the mobile station 10 in the selected time-slot t using the transmission power associated by the downlink power sequence for the second cell to this time-slot.

The same process described with reference to steps 222 to 225 of FIG. 2 is carried out for all other mobile stations 15 in the cell for which there is data in queue. (step 226)

Further, the process is repeated at regular intervals for all mobile stations 10, 15. The length of the intervals may depend, for example, on the frequency at which the mobile stations 10, 15 measure the required path losses. Alternatively, it may also be repeated much more frequently than the measurement of the path losses, for example in each frame, which may last less than one millisecond.

By knowing the link throughput, that is, the achievable capacity, beforehand, the base station 30 can thus schedule packet transmissions such that capacity-requests (CR) in the queue for a served cell will be optimally ordered and served according to the achievable capacity. Furthermore, an optimal scheduling decision can be made to maximize the cell throughput.

It has to be noted that a power sequence only limits the maximum transmission power that can be used by a base station for a particular cell in a given time-slot. Nothing prevents the base station from using a lower transmission power if a sufficiently high C/I can still be obtained. This is safe to do as the estimate of the interference I is always an overestimate, because it is based on maximum allowed values. However, lowering the transmission power from the maximum allowed value leads to a waste of radio resources in the network, because the scheduling in a given cell is based on the predicted maximum interference from the interfering cells. Therefore, the above defined value ηₖ^{DL} can be understood as a figure of merit for the goodness of scheduling for mobile station k. As an example, if all mobile stations were scheduled with a value of η=0.5, at most 50% of the network capacity could be obtained. Any extra power margin should therefore be used instead to increase the information rate by a link adaption.

If required, the stored power sequences can also be amended upon request by a base station 30, 35 (step 227). In case there are certain mobile stations 15 near an edge of the cell which have a high traffic-volume, for example, the serving base station 30 may be enabled to change the power sequence associated to the cell such that the average transmission power for the cell increases. One possibility for enabling a change of assigned power sequences is that selected time-slots are defined as “wild-card” time-slots and set beforehand to a low power value in all power sequences. A base station 30, 35 can then assign a high power value to such a wild-card time-slot by a reservation scheme.

On the whole, only when one of the base stations 30, 35 changes a power sequence associated to one of its cells, for example to respond adaptively to a change in the load conditions, a communication between the base stations 30, is needed in order to update the stored power sequences for interfering cells. Hence the amount of signaling flow between base stations is expected to be minimal.

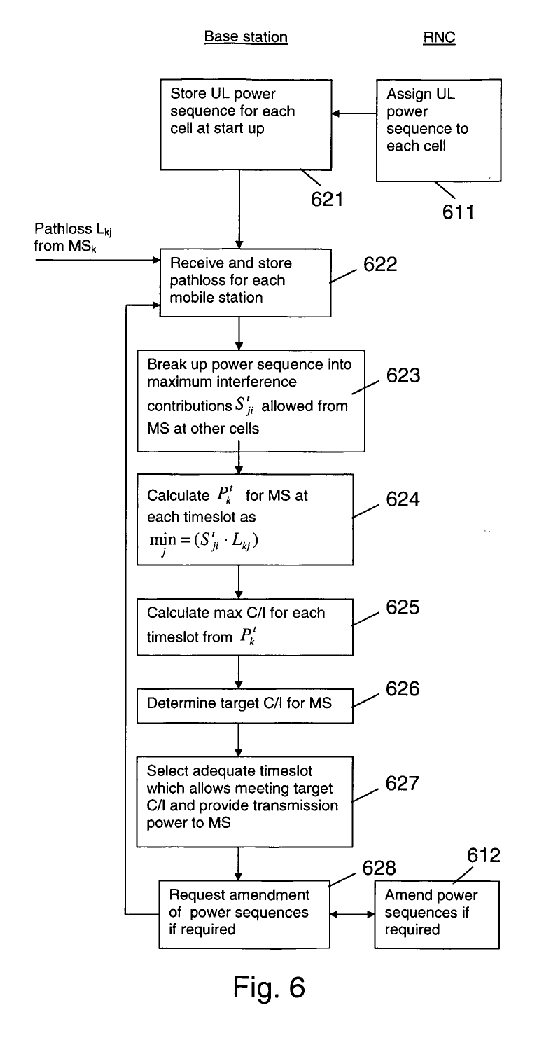

The assignment of a time-slot t to an uplink connection is a modification of the described assignment of a time-slot t to a downlink connection, which will be described in the following with reference to the flow chart of FIG. 6.

FIG. 6 presents on the left hand side the operation by the processing portion 33 of a base station 30 and on the right hand side the operation by the processing portion 21 of the RNC 20.

The RNC 20 assigns a pre-determined uplink power sequence to each cell, which may be different from the downlink power sequence assigned to the same cell. (step 611)

In the uplink case, a power sequence does not limit any transmission powers in the cell to which it is assigned, though. Instead, an uplink power sequence consists of a series of received power levels S that limit for a respective time-slot t the maximum uplink interference power a base station 30 shall receive in a serving cell from all interfering cells. The uplink power sequences associated to interfering cells should equally be “orthogonal” to each other.

The path losses between a respective mobile station 10, and various base stations 30, 35 are known from the measurements carried out by the mobile stations 10, 15 in step 231 of FIG. 2 for the downlink transmissions. Therefore, the corresponding operation in the mobile station 10, 15 is not indicated again, but only the reception and storage of the path loss for each mobile station. (step 622) It is to be understood that the reception and storage are required only once, thus step 222 of FIG. 2 and step 622 of FIG. 6 are actually the same step.

The uplink power sequence for a cell i, in the present example the second cell in FIG. 1, can be written as S̅ᵢ=[Sᵢ¹, Sᵢ² . . . Sᵢⁿ], where Sᵢ^{t} is the uplink power level for the t^{th} time-slot in cell i. S̅ᵢ is now broken up into interference contributions from all interfering cells Sᵢⱼ^{t}=γᵢⱼSᵢ^{t}, where Sᵢⱼ^{t} is the maximum allowed uplink interference power received in cell i from cell j (step 623). γᵢⱼ is independent of the time-slots and is known by the base station 30. The value of γᵢⱼ is agreed upon by the base stations 30, 35 serving respective cells i and j based on a long-term interference monitoring and determined more specifically in the RNC 20. The values are selected such that

$${\sum }_{j} {γ}_{ij} = 1$$

for a respective cell i.

Next, the base station 30 serving cell i calculates the maximum allowed transmission power Pₖ^{t} for a mobile station k, in the present example mobile station 10, for all time-slots, time-slot t being used as an example. The transmission power Pₖ^{t} is calculated from the condition that the uplink interference power received at any cell j from cell i shall not exceed Sⱼᵢ^{t}:

$${P}_{k}^{t} = {min}_{j} ( {S}_{ji}^{t} \cdot {L}_{kj}^{t} ) = {min}_{j} ( {γ}_{ji} \cdot {S}_{j}^{t} \cdot {L}_{kj}^{t} )$$

where Lₖⱼ represents the path-loss from mobile station k to cell j, as indicated above. The serving cell is naturally omitted from the minimum calculation. (step 624)

Finally, the base station 30 serving cell i can now calculate for mobile station k the maximum achievable C/(I+N) for each uplink time-slot t as:

$${( C / I + N )}_{k}^{t} = {( \frac{C}{I} )}_{k}^{t} = \frac{{P}_{k}^{t} / {L}_{ki}}{{S}_{i}^{t}}$$

Noise N is assumed again to be much smaller than interference I. (step 625)

Further, the base station 30 determines a target C/I for mobile station k for each time-slot t (step 626).

The base station 30 can now calculate from the target C/I a figure of merit ηₖ^{UL}(t) for scheduling uplink transmissions by mobile station k to a particular time-slot t:

$${η}_{k}^{UL} ( t ) ≡ \frac{{\sum }_{j} {P}_{k}^{t} {L}_{kj}}{{\sum }_{j} {γ}_{ji} \cdot {S}_{j}^{t}} \cdot {( \frac{C}{I} )}_{k}^{Target} / {( \frac{C}{I} )}_{k}^{t} \underline{<} 1$$

The figure of merit is similar to the figure of merit in the downlink case, but it has an additional multiplier that accounts for how much of the allocated interference budget cell i is able to use. The summations for the additional multiplier go over those cells j for which γⱼᵢ16 0. The closer the figure of merit is to unity, the better will be the usage of the network radio resources. For each mobile station k in cell i, the base station 30 thus selects the time-slot t that results in an adequate C/I, that is, the C/I with the highest value of ηₖ^{UL} below one. The time-slot t selected for mobile station k and the maximum transmission power Pₖ^{t} calculated in step 624 for mobile station k and this time-slot t are transmitted to the respective mobile station k. (step 627)

The mobile station 10 may then transmit packets to the base station 30 in the selected time-slot t using the indicated transmission power Pₖ^{t}.

The uplink power sequences may be amended if required. (step 628) in cooperation between the base stations 30, via the RNC 20 (step 612).

The same process described with reference to steps 622 to 627 of FIG. 6 is carried out for all other mobile stations 15 in the cell for which there is data in queue (not shown).

With the operations presented with reference to FIGS. 2 and 6, thus only the downlink and uplink power sequences have to be communicated at a start up from the RNC 20 to the base stations 30, 35 for allocating suitable timeslots and transmission powers to downlink and uplink connections. No further signaling is needed in the network, unless the power sequences are to be changed. In addition, only the path loss measurements made by the mobile terminals 10, 15 are required at the base stations 30.

In the following, some possibilities of amending the power sequences and of optimizing the time-slot allocation will be dealt with in more detail.

In a high load situation, the assigned power sequences offer time-slots for each cell in which the interference level from other cells is low and the cell itself can use higher powers. A base station 30 uses such time-slots for mobile stations 10, 15 requiring a high C/I or for those mobile stations 10, 15 that are far away from the base station 30. If there are not enough such time-slots permitting a high transmission power available for a cell, the queue starts growing. If the queue for one cell gets much longer than those of surrounding cells, the serving base station 30 could negotiate with the other base stations 35 to adopt a power sequence that is more suitable for serving such mobile stations, or use the proposed reservation mechanism. This would not lead to a large amount of signaling, because these are much longer-term adaptations than the typical scheduling cycle. If all cells have growing queues, this implies a network overload situation.

In low load situation, the allocated power sequences could have a plurality of “wild-card” time-slots, that is, time-slots with a low value in all download power sequences and a high value in all uplink power sequences. The base station could then “reserve” one of these time-slots for longer periods of time. The reservation of downlink wild-card time-slots happens by obtaining a high transmission power permit for that slot. In the uplink, reserving a “wild-card” time-slot would mean obtaining a low reception interference power allowance. In such cases, it might frequently happen that the cell is not able to fulfill the interference budget given to it, but this situation is acceptable when the load is low.

When the network load grows, the network could then start allocating power sequences with less and less wild-card time-slots. All these are statistical changes with low signaling load among the base stations.

For further improving the time-slot allocation, a base station can moreover optimally shuffle the order of capacity requests based on a predicted C/I at each time-slot so that the achievable throughput is maximized. For example, in case two time-slots have to be allocated to two mobile stations, the values of a figure of merit could be 0.5 and 0.6, respectively, for the time-slots for mobile station 1 and 0.2 and 0.9, respectively, for the time-slots for mobile station 2. Without optimization, mobile station 1 might simply chooses a time-slot first. In this case, the first time slot will be allocated to mobile station 2 and the second time-slot will be allocated to mobile station 1, although it might be a more optimal order to allocate the first time-slot to mobile station 1 and the second time-slot to mobile station 2.

A more optimized distribution could be achieved in several ways. In a first approach, for example, the highest ratio is chosen first. In the above example, this means that first, the 0.9 time-slot is chosen for mobile station 2. In a second approach, the minimum ratio of all users is maximized. In the above example, this means that selecting the 0.5 time-slot for mobile station 1 is better than selecting the 0.2 time-slot for mobile station 2.

It is to be noted that the described embodiment can be varied in many ways and that it moreover constitutes only one of a variety of possible embodiments of the invention. For instance, the presented algorithm, which supports packet scheduling decisions, is only exemplary. Also other schemes that utilize the idea of maximizing the usage of allocated interference budgets by means of using known power sequences and path loss measurements from mobile stations to base stations can be employed.

1. A method for supporting in a wireless communication system an allocation of radio resources to connections between mobile stations and access stations of a wireless communication network, wherein each access station serves at least one sub-area, wherein each connection uses at least one radio resource, and wherein a respective power set is associated to each sub-area served by one of said access stations, said method comprising in said wireless communication network:
receiving an indication of radio measurements performed by a mobile station on signals received at said mobile station from a plurality of sub-areas; and
predicting for a plurality of radio resources a respective value indicating a signal quality, which signal quality can be expected to occur in a connection between said mobile station and an access station when using a particular radio resource, based on power sets associated to said plurality of sub-areas and on said radio measurements performed by said mobile station.

2. The method according to claim 1, further comprising selecting a radio resource for a connection between said mobile station and said access station based on said predicted value indicating a signal quality which can be expected to occur with various radio resources.

3. The method according to claim 2, wherein selecting said radio resource comprises comparing said predicted value indicating a signal quality to a target value indicating a signal quality.

4. The method according to claim 3, wherein said target value indicating a signal quality is selected by means of a mapping table, which mapping table maps a desired link performance or a desired link throughput to a respective target value indicating a signal quality.

5. The method according to claim 1, wherein said radio measurements comprise at least one of a path loss of signals received from various sub-areas at said mobile station and a reception power of signals received from various sub-areas at said mobile station.

6. The method according to claim 1, wherein said value indicating a signal quality in a received signal is at least one of a carrier-to-interference ratio of said received signal, a signal-to-noise ratio of said received signal and a energy-per-bit-to-noise-density ratio of said received signal.

7. The method according to claim 1, wherein said assigned power sets are formed depending on a load situation in said wireless communication system.

8. The method according to claim 1, wherein said assigned power sets offer to each sub-area at least one radio resource which can be used with a high transmission power for a connection.

9. The method according to claim 1, wherein said connection is a downlink connection and wherein said power sets comprise downlink power sets, each downlink power set associating for a particular sub-area maximum downlink transmission power levels to radio resources.

10. The method according to claim 9, wherein a radio resource is allocated to a downlink connection for which said predicted value indicating a signal quality exceeds a target value indicating a signal quality.

11. The method according to claim 10, wherein said radio resource for a downlink connection is further selected such that it uses a power budget assigned to each sub-area by the downlink power sets as maximally as possible.

12. The method according to claim 9, wherein in a low load situation in said wireless communication system, assigned downlink power sets are formed such that for at least one specific radio resource, any of said downlink power sets assigned to a group of potentially interfering sub-areas comprises a low power level, which at least one specific radio resource can be reserved in said wireless communication network for any sub-area of said group for use with a high downlink transmission power level.

13. The method according to claim 9, wherein at least one of said access stations sends out information on at least one downlink power set associated to at least one sub-area it serves for supporting said radio measurements at said mobile stations.

14. The method according to claim 1, wherein said connection is an uplink connection and wherein said power sets comprise uplink power sets, each uplink power set associating for a particular sub-area the maximum uplink interference power levels this sub-area is allowed to receive from other sub-areas to radio resources.

15. The method according to claim 14, wherein predicting a respective value indicating a signal quality for a plurality of radio resources comprises:
breaking up uplink power sets assigned to other sub-areas than a sub-area, in which said mobile station is located, into interference contributions allowed at a maximum in said other sub-areas from said sub-area in which said mobile station is located;
calculating a respective maximum allowed transmission power for said mobile station when using said radio resources, based on said interference contributions and on said radio measurements; and
predicting a signal quality for said radio resources from said respective maximum allowed transmission power and said respective maximum uplink interference power level said sub-area is allowed to receive from said other sub-areas.

16. The method according to claim 15, wherein a radio resource is selected for an uplink connection between said mobile station and said access station, for which said predicted value indicating a signal quality exceeds a target value indicating a signal quality, and wherein a transmission power calculated for said selected radio resource is transmitted to said mobile station.

17. The method according to claim 16, wherein said radio resource for an uplink connection is further selected such that it uses a power budget assigned to each sub-area by the uplink power sets as maximally as possible.

18. The method according to claim 14, wherein in a low load situation in said wireless communication system, assigned uplink power sets are formed such that for at least one specific radio resource, any of said uplink power sets assigned to a group of potentially interfering sub-areas comprises a high uplink interference power level, which at least one specific radio resource can be reserved in said wireless communication network for any sub-area of said group for use with a low uplink interference power level.

19. A processing component for a network element of a wireless communication network supporting in a wireless communication system an allocation of radio resources to connections between mobile stations and access stations of said wireless communication network, each access station serving at least one sub-area, wherein each connection in said wireless communication system uses at least one radio resource, and wherein a respective power set is associated to each sub-area served by one of said access stations,
wherein said processing component is adapted to receive an indication of radio measurements performed by a mobile station for signals received at said mobile station from a plurality of sub-areas; and
wherein said processing component is adapted to predict for a plurality of radio resources a value indicating a signal quality, which can be expected to occur in a connection between said mobile station and an access station when using a particular radio resource, based on power sets associated to said plurality of sub-areas and on said radio measurements performed by said mobile station.

20. A network element for a wireless communication network comprising a processing component according to claim 19.

21. A wireless communication network comprising a network element according to claim 20.

22. The wireless communication network according to claim 21, further comprising a network element adapted to associate a respective power set to each sub-area served by one of said access stations.

23. A wireless communication system comprising a wireless communication network according to claim 21 and a plurality of mobile stations, wherein each of said mobile stations is adapted to perform radio measurements on signals received at said mobile station from a plurality of sub-areas and to provide an indication of said radio measurements to said wireless communication network.

24. A memory for storing software code for supporting in a wireless communication system an allocation of radio resources to connections between mobile stations and access stations of a wireless communication network, wherein each access station serves at least one sub-area, wherein each connection uses at least one radio resource, and wherein a respective power set is associated to each sub-area served by one of said access stations, said software code realizing the following when running in a processing portion of said wireless communication network:
receiving an indication of radio measurements performed by a mobile station on signals received at said mobile station from a plurality of sub-areas; and
predicting for a plurality of radio resources a respective value indicating a signal quality, which signal quality can be expected to occur in a connection between said mobile station and an access station when using a particular radio resource, based on power sets associated to said plurality of sub-areas and on said radio measurements performed by said mobile station.

25. (canceled)

26. An apparatus for a network element of a wireless communication network supporting in a wireless communication system an allocation of radio resources to connections between mobile stations and access stations of said wireless communication network, each access station serving at least one sub-area, wherein each connection in said wireless communication system uses at least one radio resource, and wherein a respective power set is associated to each sub-area served by one of said access stations comprising:
means for receiving an indication of radio measurements performed by a mobile station for signals received at said mobile station from a plurality of sub-areas; and
means for predicting for a plurality of radio resources a value indicating a signal quality, which can be expected to occur in a connection between said mobile station and an access station when using a particular radio resource, based on power sets associated to said plurality of sub-areas and on said radio measurements performed by said mobile station.
